(19) United States
(12) Patent Application Publication
(10) Pub. No.: US 2024/0056327 A1
(43) Pub. Date: Feb. 15, 2024

(54) INFORMATION PROCESSING DEVICE, PARTICIPANT TERMINAL, ASSISTANCE SYSTEM, INFORMATION PROCESSING METHOD, AND STORAGE MEDIUM

(71) Applicant: NEC Corporation, Minato-ku, Tokyo (JP)

(72) Inventor: Kazumi MARUYAMA, Tokyo (JP)

(73) Assignee: NEC Corporation, Minato-ku, Tokyo (JP)

(21) Appl. No.: 18/267,870

(22) PCT Filed: Mar. 25, 2021
(86) PCT No.: PCT/JP2021/012561

§ 371 Date: Jun. 16, 2023

(51) Int. Cl. H04L 12/18

(52) U.S. Cl. CPC H04L 12/1822; H04L 12/1818

(57) ABSTRACT

In order to conduct a remote conversation without depending on each individual IT skill of participants of the remote conversation, an information processing apparatus (1) includes: a decision means (21) that decides, based on terminal-specific information (71, 72) of a participant terminal (2) which is used by a participant of a remote conversation, an item (91, 92) to be decided for starting the remote conversation; and an instruction means (22) that instructs the participant terminal to execute a predetermined process for starting the remote conversation in accordance with the item which has been decided.

### TECHNICAL FIELD

The present invention relates to an information processing apparatus, a participant terminal, an assistance system, an information processing method, an assistance method, and an assistance program which assist conduct of a remote conversation.

### BACKGROUND ART

In recent years, non-face-to-face economic activities such as remote work and online medical care have been actively carried out. Along with the circumstances, the frequency of use of means for carrying out conversation between persons at distant locations through telephonic apparatuses (hereinafter, referred to as remote conversation) has increased remarkably. As a means for carrying out a remote conversation, remote conversation applications such as Zoom (registered trademark), Teams (registered trademark), WebEx (registered trademark), Skype (registered trademark) have been widely spread over a wide variety of ranges.

Furthermore, technologies for assisting a user such that a remote conversation proceeds smoothly have also been developed. For example, Patent Literature 1 proposes a technique in which, in a case where a communication load of a mobile terminal during a remote conversation has become large, a configuration scale is changed by proposing, for example, a user to carry out distributed communication to another mobile terminal, and thus communication via a network is more effectively and efficiently carried out.

### CITATION LIST

### Patent Literature

[Patent Literature 1]
Japanese Patent Application Publication Tokukai No. 2013-200695

### SUMMARY OF INVENTION

### Technical Problem

However, there are many users whose knowledge does not sufficiently catch up with the rapid development of a means of remote conversation as described above, and who take time and effort for various settings necessary for actually carrying out a remote conversation. It is demanded to assist a user from a stage where a remote conversation can be started without problem.

An aspect of the present invention is accomplished in view of the above problems, and its example object is to provide a technique which makes it possible to conduct a remote conversation without depending on each individual IT skill of participants of the remote conversation.

### Solution to Problem

An information processing apparatus according to an aspect of the present invention includes: a decision means that decides, based on terminal-specific information of a participant terminal which is used by a participant of a remote conversation, an item to be decided for starting the remote conversation; and an instruction means that instructs the participant terminal to execute a predetermined process for starting the remote conversation in accordance with the item which has been decided.

A participant terminal according to an aspect of the present invention is a participant terminal used by a participant of a remote conversation, the participant terminal including: a transmission means that transmits terminal-specific information of the participant terminal to an information processing apparatus that assists conduct of the remote conversation; a reception means that receives, from the information processing apparatus, an instruction for executing a predetermined process for starting the remote conversation in accordance with an item which has been decided by the information processing apparatus based on the terminal-specific information and which is to be decided for starting the remote conversation; and an execution means that executes the predetermined process in accordance with the instruction.

An assistance system according to an aspect of the present invention is an assistance system including a participant terminal which is used by a participant of a remote conversation and an information processing apparatus which assists conduct of the remote conversation, the information processing apparatus including a decision means that decides, based on terminal-specific information of the participant terminal, an item to be decided for starting the remote conversation, and an instruction means that instructs the participant terminal to execute a predetermined process for starting the remote conversation in accordance with the item which has been decided, and the participant terminal including a transmission means that transmits the terminal-specific information to the information processing apparatus, a reception means that receives, from the information processing apparatus, an instruction by the instruction means; and an execution means that executes the predetermined process in accordance with the instruction.

An information processing method according to an aspect of the present invention includes: deciding, by at least one processor, an item to be decided for starting a remote conversation based on terminal-specific information of a participant terminal which is used by a participant of the remote conversation; and instructing, by the at least one processor, the participant terminal to execute a predetermined process for starting the remote conversation in accordance with the item which has been decided.

A method for assisting a remote conversation according to an aspect of the present invention includes: transmitting, by a participant terminal used by a participant of a remote conversation, terminal-specific information of the participant terminal to an information processing apparatus which assists conduct of the remote conversation; deciding, by the information processing apparatus, an item to be decided for starting the remote conversation, based on the terminal-specific information; instructing, by the information processing apparatus, the participant terminal to execute a predetermined process for starting the remote conversation in accordance with the item which has been decided; receiving, by the participant terminal, an instruction for executing the predetermined process from the information processing apparatus; and executing, by the participant terminal, the predetermined process in accordance with the instruction.

An assistance program according to an aspect of the present invention is an assistance program for causing a computer to function as a participant terminal used by a participant of a remote conversation, the assistance program causing the computer to execute: a transmission process of transmitting terminal-specific information of the participant terminal to an information processing apparatus that assists conduct of the remote conversation; a reception process of receiving, from the information processing apparatus, an instruction for executing a predetermined process for starting the remote conversation in accordance with an item which has been decided by the information processing apparatus based on the terminal-specific information and which is to be decided for starting the remote conversation; and an execution process of executing the predetermined process in accordance with the instruction.

### Advantageous Effects of Invention

According to an aspect of the present invention, it is possible to assist a user to smoothly conduct a remote conversation, and possible to enable the user to conduct the remote conversation regardless of the IT skill of the user.

### BRIEF DESCRIPTION OF DRAWINGS

FIG. 1 is a block diagram illustrating a configuration of an assistance server according to a first example embodiment of the present invention.

FIG. 2 is a block diagram illustrating a configuration of a user terminal according to the first example embodiment of the present invention.

FIG. 3 is a block diagram illustrating a configuration of an assistance system according to the first example embodiment of the present invention.

FIG. 4 is a flowchart illustrating a flow of an information processing method that is carried out by the assistance server according to the first example embodiment of the present invention.

FIG. 5 is a sequence diagram illustrating a flow of a remote conversation assistance method that is carried out by apparatuses constituting the assistance system according to the first example embodiment of the present invention.

FIG. 6 is a block diagram illustrating a configuration of an assistance system 100 according to a second example embodiment of the present invention.

FIG. 7 is a diagram illustrating an example of a data structure of terminal-specific information.

FIG. 8 is a flowchart illustrating a flow of a method that is carried out by a decision section to decide a decision-necessary item.

FIG. 9 is a diagram illustrating an example of a data structure of a decision-necessary item.

FIG. 10 is a diagram illustrating an example of a notification screen that is displayed on a display section of a user terminal.

FIG. 11 is a diagram illustrating a configuration of an assistance system including an assistance server according to a third example embodiment of the present invention.

FIG. 12 is a diagram illustrating a configuration of an assistance system including a user terminal according to a fourth example embodiment of the present invention.

FIG. 13 is a block diagram illustrating an example of a hardware configuration of the assistance server and the user terminal according to each of the example embodiments of the present invention.

### EXAMPLE EMBODIMENTS

### First Example Embodiment

The following description will discuss a first example embodiment of the present invention in detail with reference to the drawings. The present example embodiment is a basic form of example embodiments described later.

(Configuration of Information Processing Apparatus)

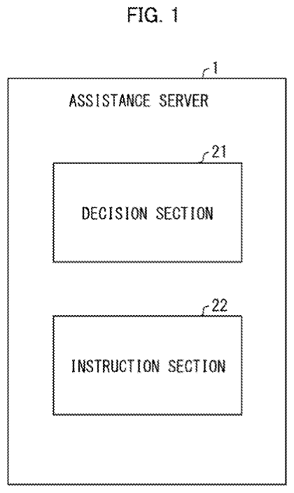

FIG. 1 is a block diagram illustrating a configuration of an assistance server 1 according to the present example embodiment. The assistance server 1 is an apparatus that realizes the information processing apparatus in the present example embodiment. The assistance server 1 executes information processing for assisting a participant in conduct of a remote conversation. The assistance server 1 may be realized by, for example, a server apparatus that communicates with one or more user terminals. The user terminal is an apparatus which is used by a user, who is a participant of a remote conversation, for participating in the remote conversation.

As illustrated in FIG. 1, the assistance server 1 includes a decision section 21 and an instruction section 22. The decision section 21 is configured to realize the decision means in the present example embodiment. The instruction section 22 is configured to realize the instruction means in the present example embodiment.

The decision section 21 decides, based on terminal-specific information of a participant terminal which is used by a participant of a remote conversation, an item to be decided for starting the remote conversation. The terminal-specific information is a generic term of information which is individually held by a participant terminal. The terminal-specific information may include information that is specific to a participant terminal and that corresponds only to the participant terminal. The terminal-specific information may include information which is shared among a plurality of participant terminals including the participant terminal and another participant terminal. The terminal-specific information may include, for example, information which is individually held by a participant terminal and which pertains to a remote conversation. The information pertaining to a remote conversation may include, for example, information pertaining to a remote conversation which is scheduled to be held, and information pertaining to hardware and software which are used to conduct the remote conversation with the participant terminal.

The instruction section 22 instructs the participant terminal to execute a predetermined process for starting the remote conversation in accordance with the item which has been decided.

The assistance server 1 may be realized by a computer and a control program. The control program is a control program that causes the computer to function as the decision section 21 and the instruction section 22 described above.

(Configuration of Participant Terminal)

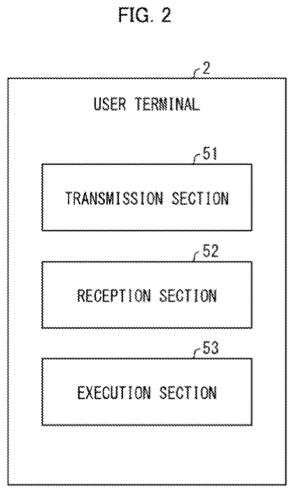

FIG. 2 is a block diagram illustrating a configuration of a user terminal 2 according to the present example embodiment. The user terminal 2 may be realized by, for example, a smart phone, a tablet terminal, a personal computer (PC), a laptop PC, or the like. The user terminal 2 is an apparatus that realizes the participant terminal in the present example embodiment.

As illustrated in FIG. 2, the user terminal 2 includes a transmission section 51, a reception section 52, and an execution section 53. The transmission section 51 is configured to realize the transmission means in the present example embodiment. The reception section 52 is configured to realize the reception means in the present example embodiment. The execution section 53 is configured to realize the execution means in the present example embodiment.

The transmission section 51 transmits terminal-specific information of the user terminal 2 to an information processing apparatus that assists conduct of a remote conversation.

The reception section 52 receives, from the assistance server 1, an instruction for executing a predetermined process. The instruction for executing a predetermined process includes an instruction sentence that instructs the user terminal 2 to execute the predetermined process. Here, the predetermined process is a process for starting a remote conversation, and is various kinds of information processing that are executed by the user terminal 2 in accordance with an item which has been decided by the assistance server 1 based on terminal-specific information and which is to be decided for starting the remote conversation.

The execution section 53 executes the predetermined process in accordance with the instruction received by the reception section 52.

The user terminal 2 may be realized by a computer and an assistance program. The assistance program is a control program that causes the computer to function as the transmission section 51, the reception section 52, and the execution section 53 described above.

(Configuration of Assistance System)

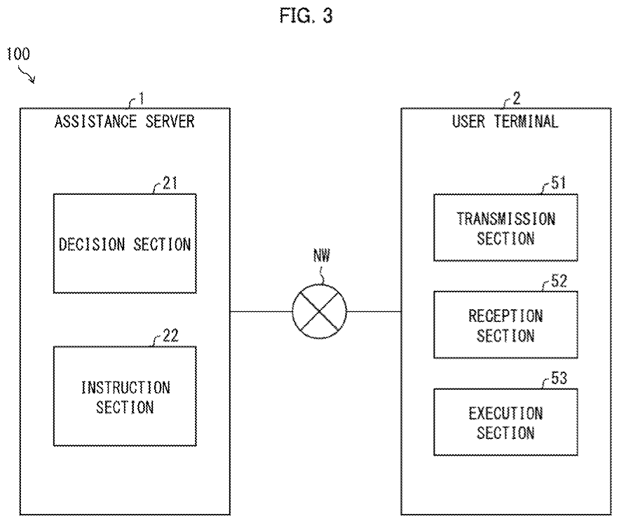

FIG. 3 is a block diagram illustrating a configuration of an assistance system 100 according to the present example embodiment. The assistance system 100 includes, for example, a user terminal 2 that is used by a participant of a remote conversation, and an assistance server 1 that assists conduct of the remote conversation.

The assistance server 1 and the user terminal 2 are communicably connected to each other via a communication network NW. The communication network NW may include one or more wide-area networks such as the Internet and private networks such as a local area network (LAN). The communication network NW may be constituted by a dedicated line that directly connects the assistance server 1 with the user terminal 2. The communication network NW may include, in some cases, a communication network such as WiFi (registered trademark) or a mobile telephone line network such as long term evolution (LTE).

The assistance server 1 includes: the decision section 21 that decides, based on terminal-specific information of the user terminal 2, an item to be decided for starting a remote conversation; and the instruction section 22 that instructs the user terminal 2 to execute a predetermined process for starting the remote conversation in accordance with the item which has been decided.

The user terminal 2 includes a transmission section 51 that transmits terminal-specific information to the user terminal 2, a reception section 52 that receives, from the assistance server 1, an instruction by the instruction section 22, and an execution section 53 that executes a predetermined process in accordance with the instruction.

(Flow of Information Processing Method)

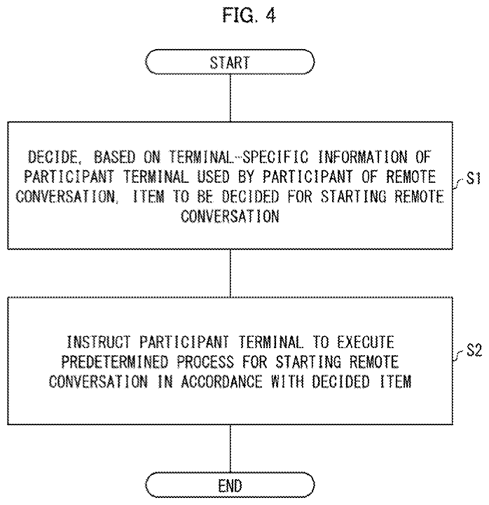

FIG. 4 is a flowchart illustrating a flow of an information processing method that is carried out by the assistance server 1.

In step S1, the decision section 21 decides, based on terminal-specific information of a participant terminal which is used by a participant of a remote conversation, an item to be decided for starting the remote conversation.

In step S2, the instruction section 22 instructs the participant terminal to execute a predetermined process for starting the remote conversation in accordance with the item which has been decided.

(Flow of Assistance Method)

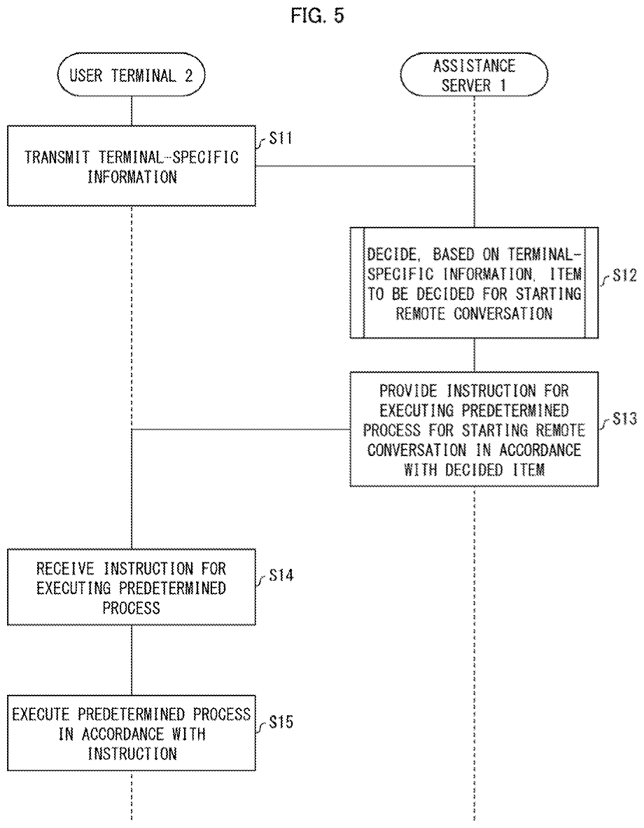

FIG. 5 is a sequence diagram illustrating a flow of a remote conversation assistance method that is carried out by apparatuses constituting the assistance system 100.

In step S11, the user terminal 2 which is used by a participant of a remote conversation transmits terminal-specific information of the user terminal 2 to the assistance server 1 which assists conduct of the remote conversation.

In step S12, the assistance server 1 decides, based on the terminal-specific information, an item to be decided for starting the remote conversation.

In step S13, the assistance server 1 instructs the user terminal 2 to execute a predetermined process for starting the remote conversation in accordance with the item which has been decided.

In step S14, the user terminal 2 receives, from the assistance server 1, an instruction on execution of the predetermined process.

In step S15, the user terminal 2 executes the predetermined process in accordance with the instruction.

### Example Effect of First Example Embodiment

As described above, the assistance server 1 according to the present example embodiment employs the configuration of including the decision section 21 and the instruction section 22.

According to the above configuration, the assistance server 1 can decide, based on terminal-specific information of a user terminal 2 (participant terminal), an item necessary for starting a remote conversation which is carried out using the user terminal 2. Moreover, the assistance server 1 can instruct the user terminal 2 to execute a predetermined process for starting the remote conversation based on the item which has been decided.

The user terminal 2 which has received the instruction can execute the predetermined process as instructed. Here, the predetermined process is various kinds of information processing which are carried out for the start of a remote conversation in accordance with an item which has been decided as an item necessary for the start of the remote conversation.

The predetermined process necessary for starting the remote conversation is executed by the user terminal 2. Therefore, a user, who is a participant of the remote conversation, can easily conduct a start operation of the remote conversation in accordance with the item which has been decided. As a result, it is possible to bring about an example effect of establishing an environment in which a remote conversation can be conducted stably without depending on skills of individual participants.

As described above, the user terminal 2 according to the present example embodiment employs the configuration of including the transmission section 51, the reception section 52, and the execution section 53.

According to the above configuration, the user terminal 2 can transmit terminal-specific information to the assistance server 1, and it is possible to decide, in the assistance server 1, an item necessary for starting the remote conversation. Moreover, the user terminal 2 can receive, from the assistance server 1, an instruction on execution of a predetermined process for starting the remote conversation based on the item which has been decided. Thus, the user terminal 2 can execute the predetermined process in accordance with the instruction.

As such, the predetermined process necessary for starting the remote conversation is executed by the user terminal 2. Therefore, a user, who is a participant of the remote conversation, can easily conduct a start operation of the remote conversation in accordance with the item which has been decided. As a result, it is possible to bring about an example effect of establishing an environment in which a remote conversation can be conducted stably without depending on skills of individual participants.

As described above, the assistance system 100 according to the present example embodiment employs the configuration of including the assistance server 1 and the user terminal 2 described above. Therefore, according to the configuration of the assistance system 100, it is possible to bring about an example effect of establishing an environment in which a remote conversation can be conducted stably without depending on skills of individual participants.

As described above, the information processing method according to the present example embodiment employs the configuration of including the foregoing steps S1 and S2. Therefore, according to the above method, it is possible to bring about an example effect of establishing an environment in which a remote conversation can be conducted stably without depending on skills of individual participants.

As described above, the configuration including the foregoing steps S11 through S15 is employed in the remote conversation assistance method according to the present example embodiment. Therefore, according to the above method, it is possible to bring about an example effect of establishing an environment in which a remote conversation can be conducted stably without depending on skills of individual participants.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are omitted as appropriate.

(Configuration of Assistance System)

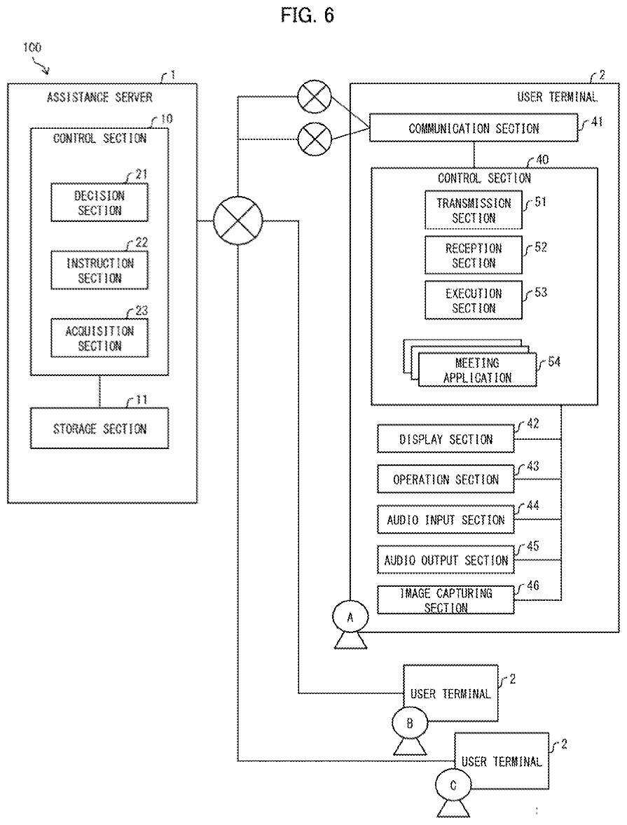

FIG. 6 is a block diagram illustrating a configuration of an assistance system 100 according to the present example embodiment. FIG. 6 also illustrates main configurations of an assistance server 1 and a user terminal 2 according to the present example embodiment.

The assistance system 100 is a system for assisting a plurality of participants participating in a remote conversation to conduct the remote conversation. The assistance system 100 includes the assistance server 1 according to the present example embodiment and user terminals 2 according to the present example embodiment which are respectively used by users who are participants of the remote conversation.

In the present example embodiment and example embodiments described later, it is assumed that, for example, a remote conversation is a meeting (hereinafter, referred to as “web meeting”) which is carried out by transmission and reception of audiovisual data via a communication network by users using user terminals 2 at locations remote from each other. Note, however, that the remote conversation which can be assisted by the assistance system 100 of the present disclosure is not limited to web meetings. The assistance system 100 can provide assistance of participants for any remote conversations, such as an online medical care, an online seminar, an online drinking party, and the like, in which a conversation between persons at distant locations takes place in real time via a communication network.

Hereinafter, means for conducting a web meeting (remote conversation) are collectively referred to as a web meeting service (remote conversation service). It is assumed that the web meeting service is provided to each user from a service provider providing the service. The web meeting service may be made available with the user terminal 2 by installing, in the user terminal 2, an application program delivered by the service provider. Alternatively, the web meeting service may be made available with the user terminal 2 in a manner in which the user terminal 2 accesses, via an Internet browser or the like which is installed in the user terminal 2, a web meeting server (not illustrated) which is operated by the service provider. The web meeting service can be, for example, existing web meeting services such as Zoom (registered trademark), Teams (registered trademark), WebEx (registered trademark), and Skype (registered trademark).

The “audiovisual data” is data for visually or audibly expressing utterance content of a user. In a remote conversation (web meeting in the present example embodiment), by causing users to view and listen to the audiovisual data, a non-face-to-face conversation between the users is enabled. Specific examples of the audiovisual data can be assumed to include, but not limited to, audio data, still image data, moving image data, text data, data created by any software (e.g., data of materials referred to in a conversation, such as document data, table data, graph data, and presentation data), and the like.

The assistance system 100 according to the present example embodiment may include a plurality of user terminals 2 which are respectively used in a web meeting by users (in the example of FIG. 6, a user A, a user B and a user C) participating in the web meeting. In the example illustrated in FIG. 6, the number of user terminals 2 included in the assistance system 100 is “3”, which is the same number as the number of persons participating in the web meeting. Note that the number of user terminals 2 included in the assistance system 100 may be less than three or may be more than three. The number of user terminals 2 included in the assistance system 100 may be different from the number of users participating in the web meeting. For example, in a case where two or more users participate in a web meeting using a single user terminal 2, the number of user terminals 2 included in the assistance system 100 is less than the number of users participating in the web meeting. On the contrary, a single user may participate in a web meeting using a plurality of user terminals 2.

The assistance server 1 is communicably connected to each of user terminals 2 via a communication network, and assists conduct of a web meeting at each of the user terminals 2. Specifically, the assistance server 1 instructs each of the user terminals 2 to execute a predetermined process for starting the web meeting. Details of the process will be described later.

(Configuration of Assistance Server 1)

As illustrated in FIG. 6, the assistance server 1 includes a control section 10 and a storage section 11. The control section 10 is constituted by, for example, an arithmetic apparatus such as a central processing unit (CPU) or a dedicated processor. Each section of the control section 10 which will be described later with reference to FIG. 6 can be realized by the arithmetic apparatus loading a program stored in a storage apparatus (e.g., the storage section 11) which is realized by a read only memory (ROM) or the like into a random access memory (RAM) or the like, and executing the program. The storage section 11 stores various kinds of data which are used by the control section 10. The storage section 11 may be configured as an external storage apparatus accessible by the assistance server 1.

For example, the control section 10 further includes an acquisition section 23 in addition to the decision section 21 and the instruction section 22 which have been described in the first example embodiment.

The acquisition section 23 acquires terminal-specific information which has been transmitted from the user terminal 2 before the web meeting starts. In the present example embodiment, the phrase “before the web meeting starts” assumes a time point at a predetermined time period before a scheduled start time of the web meeting that is decided to be held. For example, the time point may be 10 minutes before the scheduled start time of the web meeting. The acquisition section 23 acquires terminal-specific information from each of user terminals 2. The terminal-specific information of each of the user terminals 2 which has been acquired by the acquisition section 23 is referred to by the decision section 21.

As described in the first example embodiment, the decision section 21 decides, based on terminal-specific information of a user terminal 2 which is used by a participant of a remote conversation, an item to be decided for starting the remote conversation. Hereinafter, the item to be decided for starting the remote conversation is referred to as “decision-necessary item”.

In the present example embodiment, the decision section 21 may decide, in response to acquisition of terminal-specific information by the acquisition section 23, a decision-necessary item based on the acquired terminal-specific information. That is, the decision section 21 may decide a decision-necessary item a predetermined time period before the scheduled start time of the web meeting.

In the present example embodiment, the decision section 21 may decide a decision-necessary item in response to acquisition of at least one of several pieces of terminal-specific information by the acquisition section 23. Another piece of terminal-specific information necessary for deciding a decision-necessary item may be supplied in advance from the user terminal 2 and stored in the storage section 11 before reception of the above at least one piece of terminal-specific information (e.g., before decision of holding of a web meeting).

In a case where the acquisition section 23 has acquired at least one piece of terminal-specific information immediately before (e.g., 10 minutes before) start of the web meeting, the decision section 21 may decide, in response to the acquisition, a decision-necessary item based on the acquired at least one piece of terminal-specific information and terminal-specific information stored in the storage section 11 in advance. Note that the user terminal 2 transmits, to the assistance server 1, the terminal-specific information in association with a terminal ID for uniquely identifying the user terminal 2. In the storage section 11, the terminal-specific information is stored in association with the terminal ID. With the configuration, when terminal-specific information of a user terminal 2 has been acquired, the decision section 21 can read, form the storage section 11, the terminal-specific information of the same user terminal 2 based on a terminal ID. Details of the terminal-specific information will be described later.

In the present example embodiment, the decision section 21 may decide a decision-necessary item based on pieces of terminal-specific information of respective two or more user terminals 2. Furthermore, the decision section 21 may decide, based on a plurality of pieces of terminal-specific information which have been acquired from respective user terminals 2 of a plurality of users participating in the same web meeting, a decision-necessary item which is common to the user terminals 2 used in the same web meeting. Alternatively, the decision section 21 may decide a decision-necessary item specific to a user terminal 2 of one user based on one piece of terminal-specific information acquired from that user terminal 2. The decision section 21 may decide a plurality of decision-necessary items for a single web meeting. The plurality of decision-necessary items may include an item common to all of participating user terminals 2, and/or an item specific to a single user terminal 2.

For example, the decision section 21 according to the present example embodiment may decide, as decision-necessary items, (A) a type of web meeting service used for carrying out a web meeting, (B) a type of audiovisual equipment that is used by participants in a web meeting, and (C) a type of network that is used by a user terminal 2 for carrying out the web meeting. Details of these will be described later.

For example, the acquisition section 23 may acquire, as terminal-specific information, information pertaining to a network environment of each of user terminals 2 from the user terminals 2 of all users participating in the same web meeting. Hereinafter, information pertaining to a network environment of a user terminal 2 is referred to as network information. The decision section 21 may decide, for each user terminal 2, a network to be used by the user terminal 2 in a web meeting based on pieces of network information of all participants. For example, the decision section 21 may select, for each user terminal 2, a network having a comparable communication rate so that an excessive delay between user terminals 2 does not occur as much as possible.

As described in the first example embodiment, the instruction section 22 instructs the user terminal 2 to execute a predetermined process for starting a remote conversation in accordance with the decision-necessary item which has been decided. In the present example embodiment, the instruction section 22 provides, for each user terminal 2, an instruction for executing a predetermined process for starting the web meeting in accordance with the decision-necessary item.

In the present example embodiment, the instruction section 22 may instruct, in response to acquisition of terminal-specific information by the acquisition section 23, a user terminal 2 which has transmitted the terminal-specific information to execute the predetermined process. For example, the instruction section 22 may transmit, a predetermined time period before a scheduled start time of a web meeting, an instruction based on a decision-necessary item which has been decided by the decision section 21 to the user terminal 2.

In the present example embodiment, the predetermined process may be a process of notifying participants of a decision-necessary item which has been decided by the decision section 21.

(Configuration of User Terminal 2)

As illustrated in FIG. 6, the user terminal 2 includes a control section 40, a communication section 41, a display section 42, an operation section 43, an audio input section 44, an audio output section 45, and an image capturing section 46. The control section 40 is constituted by, for example, an arithmetic apparatus such as a CPU or a dedicated processor. Each section of the control section 40 which will be described later with reference to FIG. 6 can be realized by the arithmetic apparatus loading a program stored in a storage apparatus (not illustrated) which is realized by a ROM or the like into a RAM or the like, and executing the program. The storage apparatus can be built into the user terminal 2 or may be an external storage apparatus accessible by the user terminal 2.

The communication section 41 is a communication apparatus for communicating with another apparatus (such as the assistance server 1) via a communication network NW. Note that the communication section 41 may communicate with another apparatus via an accessible external communication apparatus (e.g., wireless LAN router) and the communication network NW. Examples of the communication network NW include, but not limited to, the Internet, a carrier network which is a network established by a telecommunications carrier, and the like.

The display section 42 is a display apparatus for displaying an image and text generated by the user terminal 2 and an image and text received from another apparatus. In the present example embodiment, the display section 42 is a piece of audiovisual equipment for outputting audiovisual data such as an image or text. Here, the image is assumed to include a still image and a video (moving image). For example, the display section 42 displays, during a web meeting, at least one of an image captured by the user terminal 2 itself, an image received from another user terminal 2 of another meeting participant, and text input by the user himself/herself or by another meeting participant. The display section 42 may be a display apparatus which is built into the user terminal 2 or may be an external display apparatus which is connected to the user terminal 2 via an input-output interface included in the user terminal 2.

The operation section 43 is an input apparatus with which a user inputs an instruction operation with respect to the user terminal 2. In the present example embodiment, the operation section 43 functions also as a piece of audiovisual equipment that receives input for generating audiovisual data such as text. The operation section 43 may be an input apparatus which is built into the user terminal 2 or may be an input apparatus which is connected to the user terminal 2 via an input-output interface included in the user terminal 2. The operation section 43 may be, for example, a hardware button which is provided on the user terminal 2 or may be a touch panel which is integrally formed with the display section 42. The operation section 43 may be a keyboard, a mouse, or the like which is connected to the user terminal 2 via an input-output interface. Note, however, that the operation section 43 is not limited to these examples.

The audio input section 44 is an audio input apparatus for inputting audio generated around the user terminal 2 into the user terminal 2 as audio data. In the present example embodiment, the audio input section 44 is a piece of audiovisual equipment that receives input of audio for generating audio data which is audiovisual data. The audio input section 44 may be an audio input apparatus which is built into the user terminal 2 or may be an audio input apparatus which is connected to the user terminal 2 via an input-output interface included in the user terminal 2. A specific example of the audio input section 44 is, but not limited to, a microphone.

The audio output section 45 is an audio output apparatus for outputting audio based on audio data which has been processed by the user terminal 2 and audio based on audio data which has been received from another apparatus. In the present example embodiment, the audio output section 45 is a piece of audiovisual equipment that outputs audio based on audio data which is audiovisual data. The audio output section 45 may be an audio output apparatus which is built into the user terminal 2 or may be an audio output apparatus which is connected to the user terminal 2 via an input-output interface included in the user terminal 2. Specific examples of the audio output section 45 include, but not limited to, a speaker which is built into the user terminal 2, earphones, headphones, or a speaker which is connected to the user terminal 2 via an input-output interface.

Note that the audio input section 44 and the audio output section 45 may be integrated. In this example, the audio input section 44 and the audio output section 45 may be realized as, for example, a headset.

The image capturing section 46 is an image capturing apparatus that captures images of the surroundings of the user terminal 2. In the present example embodiment, the image capturing section 46 is a piece of audiovisual equipment that captures an image that is audiovisual data. The image capturing section 46 may be an image capturing apparatus which is built into the user terminal 2 or may be an image capturing apparatus which is connected to the user terminal 2 via an input-output interface included in the user terminal 2. A specific example of the image capturing section 46 is, but not limited to, a camera.

Note that the user terminal 2 does not need to include all the display section 42, the operation section 43, the audio input section 44, the audio output section 45, and the image capturing section 46. The display section 42, the operation section 43, the audio input section 44, the audio output section 45, and the image capturing section 46 may be connected to the user terminal 2 via short-range wireless communication such as Bluetooth (registered trademark).

The control section 40 includes, for example, a meeting application 54 in addition to the transmission section 51, the reception section 52, and the execution section 53 which have been described in the first example embodiment.

The meeting application 54 is an application which is installed to enable the user terminal 2 to use a web meeting service. The meeting application 54 may be a dedicated application of an individual web meeting service or may be a general-purpose application for enabling utilization of a web meeting service. The dedicated application is assumed to be, for example, an application such as Zoom (registered trademark), Teams (registered trademark), WebEx (registered trademark), or Skype (registered trademark). The general-purpose application is assumed to be, for example, a general web browser or the like.

In the present example embodiment, as illustrated in FIG. 6, it is assumed that a plurality of meeting applications 54 are installed in the user terminal 2. Note, however, that a single meeting application 54 may be installed in the user terminal 2.

Upon receipt of an input signal based on a predetermined input operation via the operation section 43 or the like, the control section 40 activates any of the meeting applications 54. Thus, a program of the activated meeting application 54 is loaded into a RAM or the like and is executed, and functions of the activated meeting application 54 are realized.

The transmission section 51, the reception section 52, and the execution section 53 according to the present example embodiment are configured to realize an assistance application according to an example aspect of the present invention, which is an application for assisting conduct of a web meeting. The assistance application (transmission section 51, reception section 52, and execution section 53) according to an example aspect of the present invention is realized by loading an assistance program according to an example aspect of the present invention, which is stored in a storage apparatus (not illustrated) of a user terminal 2, into a RAM or the like and executing the assistance program by the control section 40.

In the present example embodiment, the transmission section 51 refers to a clock apparatus (not illustrated) and waits until a predetermined time period before a scheduled start time of a web meeting. Note that the scheduled start time is assumed to be stored in a storage apparatus (not illustrated). The scheduled start time may be information input into an application that is installed in the user terminal 2 and that manages a schedule of a user.

When the current time indicated by the clock apparatus is a predetermined time period before the scheduled start time of the web meeting, the transmission section 51 transmits, to the assistance server 1, terminal-specific information of the user terminal 2. The transmission section 51 may read terminal-specific information which is stored in advance in a storage apparatus (not illustrated) and transmit the terminal-specific information to the assistance server 1. The transmission section 51 may transmit, to the assistance server 1, input information input from the user via the operation section 43 as terminal-specific information at a predetermined time period before the scheduled start time.

For example, at a predetermined time period before the scheduled start time, the transmission section 51 may notify the user of the fact, and cause the display section 42 to display a message prompting input of input information. For example, the transmission section 51 may cause the display section 42 to display a graphical user interface (GUI) screen including (i) a message indicating that the time is a predetermined time period before the scheduled start time and (ii) a user interface component (hereinafter, referred to as a UI component) for inputting input information.

The GUI screen which is caused by the transmission section 51 to be displayed on the display section 42 so that the user inputs input information may include, for example, the following UI component.

For example, the GUI screen may include a UI component for inputting service designation information which indicates a type of a web meeting service that is to be used in a web meeting.

The GUI screen may include a UI component for inputting data type designation information which indicates a type of audiovisual data that is transmitted and received between user terminals 2 when a web meeting is conducted. The data type designation information may be information that specifies (i) audiovisual data which is transmitted from a user terminal 2 to another user terminal 2 of another meeting participant (i.e., a type of uplink transfer data) and (ii) audiovisual data which is received from another user terminal 2 (i.e., a type of downlink transfer data) while distinguishing between those pieces of information (i) and (ii).

The GUI screen may include a UI component for inputting equipment designation information which indicates a type of peripheral equipment that is used by a user when the web meeting is conducted. The peripheral equipment is assumed to be the various types of audiovisual equipment described above for realizing a conversation, network equipment for realizing a network connection between a user terminal 2 and an external apparatus such as another user terminal 2 of another meeting participant, and the like.

In each of the above described various UI components, an option may be provided for the user to select not to designate the type of a web meeting service, the type of audiovisual data, and the type of peripheral equipment.

Alternatively, in the present example embodiment, the transmission section 51 may generate terminal-specific information based on a state of the user terminal 2 at a predetermined time period before the scheduled start time, and transmit the terminal-specific information to the assistance server 1.

For example, the transmission section 51 may generate network information of the user terminal 2, and transmit the network information to the assistance server 1 as terminal-specific information. For example, at a predetermined time period before the scheduled start time, the transmission section 51 verifies communication performance of a communication network usable by the user terminal 2, and generates network information. In a case where there is a communication network whose communication performance is poorer as compared with a normal state (e.g., a throughput is half or less of that in the normal state), the transmission section 51 may provide notification for prompting a user to change the place in order to improve the communication performance. For example, the transmission section 51 may cause the display section 42 to display the above notification.

In another example, at a predetermined time period before the scheduled start time, the transmission section 51 may identify a processing load of the user terminal 2, and generate load information indicating the identified processing load. The transmission section 51 may transmit the load information to the assistance server 1 as terminal-specific information. The transmission section 51 may determine, at a predetermined time period before the scheduled start time, availability of each piece of audio equipment usable through the user terminal 2 at the predetermined time period before the scheduled start time, and generate availability information indicating whether or not the each piece of audiovisual equipment can be used. The transmission section 51 may transmit, to the assistance server 1, the generated availability information as terminal-specific information.

As described above, the transmission section 51 transmits, to the assistance server 1 via the communication section 41, terminal-specific information including at least one of input information (such as service designation information, data type designation information, and equipment designation information), network information, load information, and availability information.

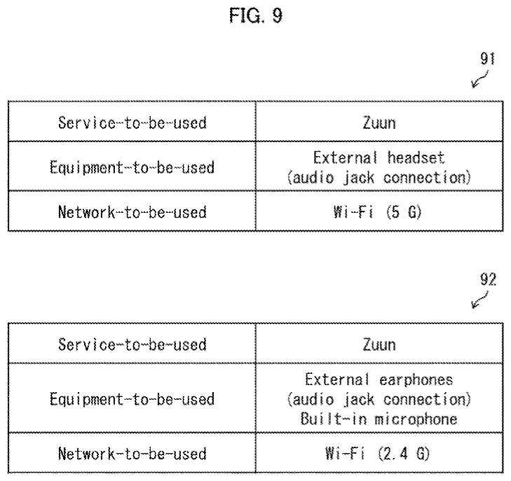

The reception section 52 according to the present example embodiment receives, from the assistance server 1, an instruction for executing a predetermined process for starting a web meeting in accordance with a decision-necessary item decided by the assistance server 1. For example, the reception section 52 may receive, as the above instruction, a decision-necessary item illustrated in FIG. 9 which will be described later. The decision-necessary item received by the reception section 52 is referred to by the execution section 53.

The execution section 53 according to the present example embodiment executes a predetermined process for starting a web meeting in accordance with a decision-necessary item received by the reception section 52.

For example, the execution section 53 may execute, as a specific example of the predetermined process, a process of notifying the user of the above decision-necessary item. More specifically, the execution section 53 may cause the display section 42 to display a list of one or more decision-necessary items.

(Data Structure of Terminal-Specific Information)

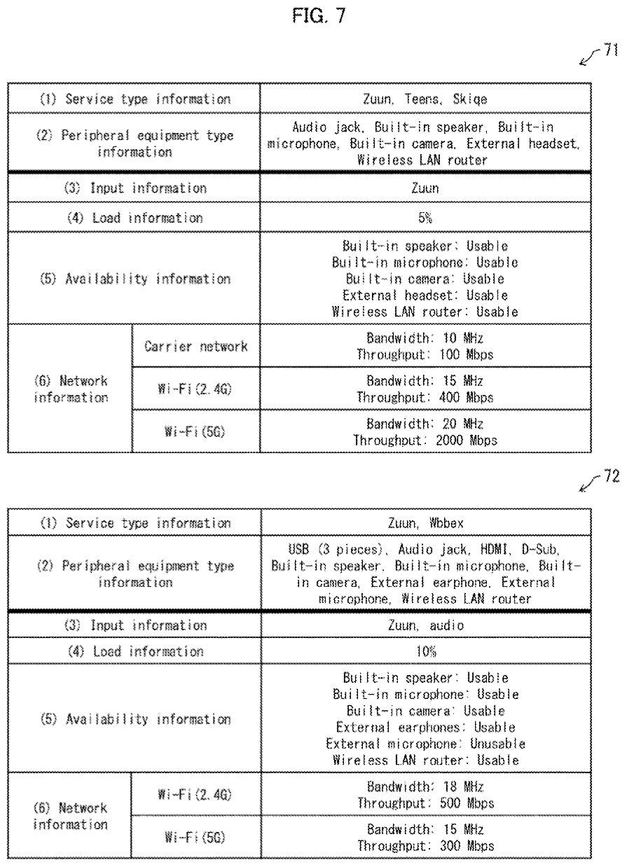

FIG. 7 is a diagram illustrating an example of a data structure of terminal-specific information. Terminal-specific information 71 is terminal-specific information of a user terminal 2 which is used by the user A illustrated in FIG. 6. Terminal-specific information 72 is terminal-specific information of a user terminal 2 which is used by the user B illustrated in FIG. 6. Although not illustrated in FIG. 7, in the present example embodiment, terminal-specific information of a user terminal 2 which is used by the user C is supplied to the assistance server 1. In the present example embodiment, the decision section 21 of the assistance server 1 may decide a decision-necessary item based on three pieces of terminal-specific information of the respective user terminals 2 of all participants (i.e., user A, user B, and user C) who participate in the same web meeting.

Hereinafter, a data structure of terminal-specific information will be described with reference to the terminal-specific information 71 as an example. Note, however, that the terminal-specific information 72 of the user terminal 2 of the user B and the terminal-specific information (not illustrated) of the user terminal 2 of the user C may also have a similar data structure.

In the present example embodiment, for example, the user terminal 2 which is used by the user A is assumed to be a smart phone, and the terminal-specific information 71 is terminal-specific information of the user terminal 2 which is the smart phone. Moreover, the user terminal 2 which is used by the user B is assumed to be a PC, and the terminal-specific information 72 is terminal-specific information of the user terminal 2 which is the PC.

For example, in the present example embodiment, one or more pieces of terminal-specific information are transmitted to the assistance server 1 per user terminal 2. In the example illustrated in FIG. 7, six pieces of terminal-specific information, i.e., (1) service type information, (2) peripheral equipment type information, (3) input information, (4) load information, (5) availability information, and (6) network information are transmitted to the assistance server 1 per user terminal 2. The transmission section 51 may transmit, to the assistance server 1, the six pieces of terminal-specific information separately at different timings, or may transmit, a predetermined time period before the scheduled start time of the web meeting, the six pieces of terminal-specific information collectively as a single piece of terminal-specific information 71. The transmission section 51 may transmit, before holding of a web meeting is decided, information pertaining to a user terminal 2 which has been fixed before holding of the web meeting is decided to the assistance server 1. Examples of such information include (1) service type information, (2) peripheral equipment type information, and the like.

That is, among pieces of terminal-specific information, (1) service type information and (2) peripheral equipment type information may be registered in advance in the storage section 11 of the assistance server 1 in association with a terminal ID. Among pieces of terminal-specific information, (3) input information, (4) load information, (5) availability information, and (6) network information may be transmitted from the user terminal 2 to the assistance server 1 a predetermined time period before a scheduled start time of a web meeting.

The above described types of terminal-specific information and the transmission timing of each piece of terminal-specific information are merely examples. Which piece of terminal-specific information is registered in advance and which piece of terminal-specific information is transmitted a predetermined time period before a scheduled start time may be appropriately selected in accordance with conditions and the like with which the assistance system 100 is operated.

The (1) service type information is information indicating a type of a web meeting service that is usable by the user terminal 2 to carry out a web meeting. For example, according to the terminal-specific information 71, the assistance server 1 can recognize that three meeting applications 54, i.e., “Zuun”, “Teens” and “Skiqe” are available as web meeting services for the user terminal 2 which is used by the user A.

The (2) peripheral equipment type information is information indicating a type of peripheral equipment that is usable by the user terminal 2 to conduct a web meeting. The peripheral equipment includes audiovisual equipment which is built into the user terminal 2, audiovisual equipment which is connectable to the user terminal 2 via an input-output interface, and network equipment which enables the user terminal 2 to connect to a communication network. Note that the peripheral equipment type information may include, instead of indicating a type of audiovisual equipment, connection terminal information indicating a type of input-output interface included in the user terminal 2.

For example, according to the terminal-specific information 71, the assistance server 1 can recognize that the user terminal 2 used by the user A is provided with an audio jack as an input-output interface, and is provided with a built-in speaker, a built-in microphone, and a built-in camera as audiovisual equipment. Furthermore, according to the terminal-specific information 71, the assistance server 1 can recognize that an external headset can be used by connecting the external headset to the user terminal 2 via the above audio jack (input-output interface). According to the terminal-specific information 71, the assistance server 1 can recognize that the user terminal 2 is connectable to a communication network via a wireless LAN router as network equipment.

The (3) input information is information which has been input, at a predetermined time period before a scheduled start time of a web meeting, from the user into the user terminal 2 via the operation section 43 in regard to the web meeting that is scheduled to be held. As described above, the input information includes at least one of service designation information, data type designation information, and equipment designation information.

For example, the terminal-specific information 71 includes “Zuun” which is service designation information as input information. With the configuration, the assistance server 1 can recognize that “Zuun” has been designated as a web meeting service that is used by the user A for a web meeting. Note that the terminal-specific information 72 includes, as input information, “Zuun” which is service designation information and “audio” which is data type designation information. With this configuration, the assistance server 1 can recognize that “Zuun” has been designated as a web meeting service that is used by the user B for the web meeting, and that audio data has been designated as audiovisual data that is transmitted and received in the web meeting.

Note that the data type designation information may include (i) information designating a type of audiovisual data which is transmitted from the user terminal 2 (uplink transfer data) and (ii) information designating a type of audiovisual data which is received by the user terminal 2 from another user terminal 2 (downlink transfer data), while distinguishing between those pieces of information (i) and (ii). That is, the user may separately designate audiovisual data which is transmitted from the user terminal 2 and audiovisual data which is received by the user terminal 2.

The (4) load information is, as an example of the load information, information indicating a processing load of a CPU of the user terminal 2 at a predetermined time period before a scheduled start time of a web meeting. For example, according to the terminal-specific information 71, the assistance server 1 can recognize that 5% of a processing load is applied to the user terminal 2 used by the user A immediately before the start of the web meeting. Moreover, according to the terminal-specific information 72, the assistance server 1 can recognize that 10% of a processing load is applied to the user terminal 2 used by the user B immediately before the start of the web meeting.

The (5) availability information is information indicating, for each piece of peripheral equipment of the user terminal 2, a status of availability at a predetermined time period before a scheduled start time of a web meeting. According to the terminal-specific information 71, the assistance server 1 can recognize that all pieces of audiovisual equipment (built-in speaker, built-in microphone, built-in camera, and external headset) of the user terminal 2 which is used by the user A are usable at a predetermined time period before the scheduled start time of the web meeting. According to the terminal-specific information 71, the assistance server 1 can recognize that, in the user terminal 2 of the user A, communication using a wireless LAN router can be carried out at a predetermined time period before the scheduled start time of the web meeting. According to the terminal-specific information 72, the assistance server 1 can recognize that, among pieces of peripheral equipment, an external microphone is unusable at a predetermined time period before the scheduled start time of the web meeting. Here, the term “unusable” means, for example, that an unusable piece of peripheral equipment cannot be recognized, or that the piece of audiovisual equipment can be recognized but the piece of audiovisual equipment is in an unusable state because some sort of problem such as a failure has occurred in that piece of audiovisual equipment. For example, in a case of a piece of audiovisual equipment which is connected via an input-output interface, if the piece of audiovisual equipment is not connected, it is determined to be “unusable”.

The (6) network information is information indicating a network environment which is usable by the user terminal 2 at a predetermined time period before the scheduled start time of the web meeting. As illustrated in FIG. 7, the network information includes a type of a communication network that is usable by the user terminal 2, and communication performance of each communication network.

According to the terminal-specific information 71, the assistance server 1 can recognize that the user terminal 2 of the user A is capable of communicating via three types of communication networks, i.e., a “carrier network”, “Wi-Fi (2.4 G)” and “Wi-Fi (5 G)”. For each of these communication networks, as an example of communication performance, a bandwidth and a throughput of the communication network are associated with each other.

Here, the “carrier network” is a network established by a telecommunications carrier. “Wi-Fi (2.4 G)” is a wireless network in conformity to Wi-Fi (registered trademark) which uses a frequency band of 2.4 GHz. “Wi-Fi (5 G)” is a wireless network in conformity to Wi-Fi (registered trademark) which uses a frequency band of 5 GHz. In the terminal-specific information 72 of the PC, the network information does not include communication performance related to the “carrier network”.

The terminal-specific information as described above is transmitted from each of the user terminals 2 to the assistance server 1. With the configuration, the decision section 21 of the assistance server 1 can appropriately decide a decision-necessary item of the web meeting based on the pieces of terminal-specific information of the user terminals 2.

(Flow of Method for Deciding Decision-Necessary Item)

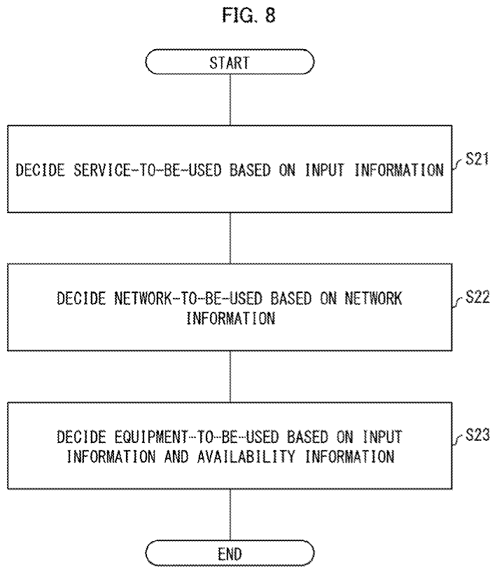

FIG. 8 is a flowchart illustrating a flow of a method that is carried out by the decision section 21 to decide a decision-necessary item. Note that the method of deciding a decision-necessary item illustrated in FIG. 8 corresponds to the process of step S12 in the assistance method illustrated in FIG. 5.

In step S21, the decision section 21 decides a decision-necessary item based on input information included in terminal-specific information of the user terminal 2 which has been acquired by the acquisition section 23. Specific examples of the decision-necessary item that is decided based on input information include a “service-to-be-used”. The service-to-be-used indicates a type of a web meeting service (remote conversation service) that is used by the user terminal 2 to conduct a web meeting (remote conversation).

In step S22, the decision section 21 decides a decision-necessary item based on network information included in terminal-specific information of the user terminal 2 which has been acquired by the acquisition section 23. Specifically, the decision section 21 decides, as a decision-necessary item, a “network-to-be-used”, which indicates a type of network that is used by the user terminal 2 for carrying out a web meeting (remote conversation). The decision section 21 decides a network-to-be-used for each of the user terminals 2. For example, the decision section 21 may select, as the network-to-be-used, a communication network having the best communication performance from among communication networks indicated in network information of the user terminal 2.

In step S23, the decision section 21 decides a decision-necessary item based on input information and availability information included in terminal-specific information of the user terminal 2 which has been acquired by the acquisition section 23. For example, the decision section 21 decides “equipment-to-be-used”, which indicates a type of audiovisual equipment that is used by a user who is a participant in a web meeting (remote conversation). Specifically, the decision section 21 may select, as the equipment-to-be-used, at least one of pieces of audiovisual equipment which are indicated, by availability information, to be usable. The decision section 21 may select equipment-to-be-used by taking into consideration data type designation information included in input information. For example, in a case where the type of uplink transfer data is designated as “audio” in the data type designation information, the decision section 21 selects the audio input section 44 (e.g., a built-in microphone or the like) as the equipment-to-be-used. Alternatively, in a case where the type of uplink transfer data is designated as “image” in the data type designation information, the decision section 21 selects the image capturing section 46 (e.g., a built-in camera or the like) as the equipment-to-be-used.

### Specific Example of Method for Deciding Decision-Necessary Item

In step S21, for example, the decision section 21 decides a service-to-be-used as a decision-necessary item based on service designation information included in input information. For example, a web meeting service that is included in both pieces of service designation information in the terminal-specific information 71 and the terminal-specific information 72 is “Zuun”. Based on this fact, the decision section 21 may decide “Zuun” as a service-to-be-used which is to be used in a web meeting that will be held.

In another example, the decision section 21 may decide a service-to-be-used based on data type designation information included in input information. For example, in a case where the data type designation information is “text”, the decision section 21 may select, as the service-to-be-used, a web meeting service having a text chat function.

In still another example, the decision section 21 may decide a service-to-be-used based on equipment designation information included in input information. For example, in a case where the equipment designation information is “phone”, the decision section 21 may select, as the service-to-be-used, a web meeting service in which a dial-in function is available.

In a case where terminal-specific information acquired by the acquisition section 23 does not include input information, the decision section 21 may omit the process of step S21.

In step S22, for example, the decision section 21 may select a network having the best communication performance among communication networks indicated by network information of the user terminal 2. Specifically, based on the terminal-specific information 71, the decision section 21 decides Wi-Fi (5 G) that has the best communication performance as a communication network that is used by the user terminal 2 of the user A. Moreover, based on the terminal-specific information 72, the decision section 21 decides Wi-Fi (2.4 G) that has the best communication performance as a communication network that is used by the user terminal 2 of the user B.

As another example, the decision section 21 may select, as the network-to-be-used, a communication network different from the communication network having the best communication performance, by further taking into consideration input information. For example, in a case where the communication network having the best communication performance is a carrier network and input information includes “video” as data type designation information, the decision section 21 may select, as the network-to-be-used, any of Wi-Fi instead of the carrier network. With this configuration, it is possible to prevent a communication traffic volume of the user terminal 2 from reaching an upper limit defined in a contract due to transmission and reception of a video having a large data size in the web meeting.

Even in a case where the communication network having the best communication performance is a carrier network, the decision section 21 may select Wi-Fi as the network-to-be-used, provided that service designation information of input information indicates a web meeting service in which text chat is carried out. Alternatively, in a case where data type designation information of input information indicates “text”, the decision section 21 may select Wi-Fi as the network-to-be-used instead of a carrier network. In these examples, audiovisual data to be transmitted and received is text having a relatively small data size. Therefore, even if a communication network having lower communication performance is selected, it is possible to conduct a web meeting without problem. With the configuration in which Wi-Fi is preferentially selected as the network-to-be-used rather than a carrier network, it is possible to prevent the communication traffic volume of the user terminal 2 from reaching the upper limit defined in the contract.

In another example, the decision section 21 may select a network-to-be-used of each user terminal 2 such that a difference in communication performance between all user terminals 2 used in a web meeting is smallest, based on network information of each of the user terminals 2 participating in the same meeting. For example, the decision section 21 may select, for a first user terminal 2 which can only be connected to a communication network having lower communication performance, a communication network having the best communication performance among communication networks each having lower communication performance. Then, the decision section 21 may select, for a second user terminal 2 which can be connected to a communication network having high communication performance, a communication network close to the communication performance of the communication network which has been selected for the first user terminal 2. Thus, it is possible to prevent an excessive delay from occurring in some user terminals 2 participating in a web meeting due to an excessive difference in communication performance.

In step S23, for example, the decision section 21 may select, as the equipment-to-be-used, at least any of pieces of audiovisual equipment that are indicated as usable by availability information, among pieces of audiovisual equipment designated by equipment designation information included in input information.

Here, the decision section 21 may decide the equipment-to-be-used based on a combination table (not illustrated) which is stored in advance in the storage section 11. The combination table is assumed to be, for example, a table in which, for each of various web meeting services used in a web meeting, (1) setting information to be set in the service in advance when holding a web meeting (information indicating a meeting date and time, a meeting room ID, a passcode, and a setting procedure of a piece of audiovisual equipment or the like), (2) a type of audiovisual data that can be transmitted and received in a web meeting based on the service, and (3) a piece of audiovisual equipment capable of inputting and outputting the audiovisual data, are associated with each other.

For example, the decision section 21 may read a record of the service-to-be-used decided in step S21 from the above combination table, and decide equipment-to-be-used, which is to be used in a web meeting, based on (2) audiovisual data type and (3) audiovisual equipment which are indicated in the record.

For example, in a case where equipment-to-be-used is previously identified based on equipment designation information included in input information, the decision section 21 may read a record associated with the audiovisual equipment from the above combination table, and decide a web meeting service associated with the record as a service-to-be-used which is to be used in the web meeting. In a case where a plurality of pieces of audiovisual equipment are identified as equipment-to-be-used based on the above equipment designation information, the decision section 21 may extract a record which is associated with all of the plurality of pieces of audiovisual equipment. In a case where a plurality of records have been extracted based on the identified piece of audiovisual equipment, the decision section 21 can decide, as the service-to-be-used, any of a plurality of web meeting services associated with the records.

The decision section 21 may further decide equipment-to-be-used based on the network-to-be-used which has been decided in step S22. In a case where any item of communication performance of a network-to-be-used decided for each of user terminals 2 does not reach communication performance sufficient for transmission and reception of audiovisual data (such as video) having a large volume, the decision section 21 may select, based on the combination table, only audiovisual equipment that inputs and outputs audio without selecting audiovisual equipment that is capable of inputting and outputting a video, as the equipment-to-be-used. Specifically, in the example of the terminal-specific information 71, it is assumed that communication performance of the decided network-of-use is not sufficient for transmission and reception of a video. In this case, even if a built-in camera is included in a record of the web meeting service “Zuun” in the combination table, the decision section 21 may remove the built-in camera from equipment-to-be-used which is used by the user A in the web meeting.

In another example, if any item of communication performance of a network-to-be-used decided for each of user terminals 2 is not sufficient for transmission and reception of a video, the decision section 21 may decide, as the service-to-be-used, a web meeting service which is not provided with a video transmission and reception function, e.g., which can transmit and receive only audio.

In still another example, the decision section 21 may decide the service-to-be-used based on load information. Specifically, if a CPU load indicated by the load information is high, the decision section 21 may decide, as the service-to-be-used, a web meeting service in which a CPU load at the time of use is the lowest.

In still another example, in a case where input information includes data type designation information, the decision section 21 may decide the equipment-to-be-used based on the data type designation information and availability information. For example, the terminal-specific information 72 includes, in input information, data type designation information indicating “audio”. The decision section 21 decides, based on the data type designation information of “audio”, audiovisual equipment capable of inputting and outputting audio, as equipment-to-be-used by the user B. Furthermore, the decision section 21 may decide equipment-to-be-used by the user B only from pieces of audiovisual equipment which are indicated as usable in availability information included in the terminal-specific information 72. For example, the decision section 21 may remove an external microphone, and decide only an external earphone and a built-in microphone as equipment-to-be-used which is used by the user B in the web meeting.

In still another example, the decision section 21 may decide equipment-to-be-used based on peripheral equipment type information and availability information. In a case where peripheral equipment type information includes connection terminal information indicating a type of input-output interface, the decision section 21 may identify audiovisual equipment connected to the input-output interface based on availability information, and decide the audiovisual equipment as equipment-to-be-used.

Note that the execution order of the steps illustrated in FIG. 8 is merely an example, and the execution order is not limited to the example of FIG. 8. For example, step S23 may be executed before step S22.

(Data Structure of Decision-Necessary Item)

FIG. 9 is a diagram illustrating an example of a data structure of a decision-necessary item that is included in an instruction transmitted to the user terminal 2 by the instruction section 22 of the assistance server 1. A decision-necessary item 91 is a decision-necessary item which has been decided based on the terminal-specific information 71. The decision-necessary item 91 is information for executing a predetermined process necessary for starting a web meeting with the user terminal 2 of the user A. A decision-necessary item 92 is a decision-necessary item which has been decided based on the terminal-specific information 72. The decision-necessary item 92 is information for executing a predetermined process necessary for starting a web meeting with the user terminal 2 of the user B.

As illustrated in FIG. 9, the decision-necessary item includes, for example, a service-to-be-used, equipment-to-be-used, and a network-to-be-used. As described above, the service-to-be-used indicates a type of web meeting service that is used in a web meeting. The equipment-to-be-used indicates a type of audiovisual equipment that is used by each of participants in a web meeting. The network-to-be-used indicates a type of communication network to which the user terminal 2 is connected in a web meeting.

The instruction section 22 transmits an instruction including the decision-necessary item 91 to the user terminal 2 of the user A and thus instructs the user terminal 2 to execute a predetermined process. Moreover, the instruction section 22 transmits an instruction including the decision-necessary item 92 to the user terminal 2 of the user B and thus instructs the user terminal 2 to execute a predetermined process. The instruction section 22 transmits, to the user terminal 2 of the user C, an instruction including a decision-necessary item (not illustrated) which has been decided based on terminal-specific information of the user terminal 2 of the user C.

(Variation of Method for Deciding Audiovisual Equipment)

The decision section 21 may decide equipment-to-be-used as a decision-necessary item to be audiovisual equipment that is not connected to the user terminal 2. In this example, the decision section 21 may transmit, to the user terminal 2, information indicating that the piece of audiovisual equipment is not connected to the user terminal 2 by including the information in an instruction which includes the decision-necessary item. Thus, the user terminal 2 is capable of notifying the user of the information.

The decision section 21 may decide equipment-to-be-used as a decision-necessary item to be audiovisual equipment that is not usable by the user terminal 2. In this example, the decision section 21 may transmit, to the user terminal 2, information indicating that the piece of audiovisual equipment is not usable by the user terminal 2 by including the information in an instruction which includes the decision-necessary item. Thus, the user terminal 2 may notify, based on the information, the user of recommendation of participating in a web meeting with use of another user terminal 2. Note that the audiovisual equipment which is not usable by the user terminal 2 is, for example, audiovisual equipment for which a connectable input-output interface is not provided to the user terminal 2.

### Screen Example

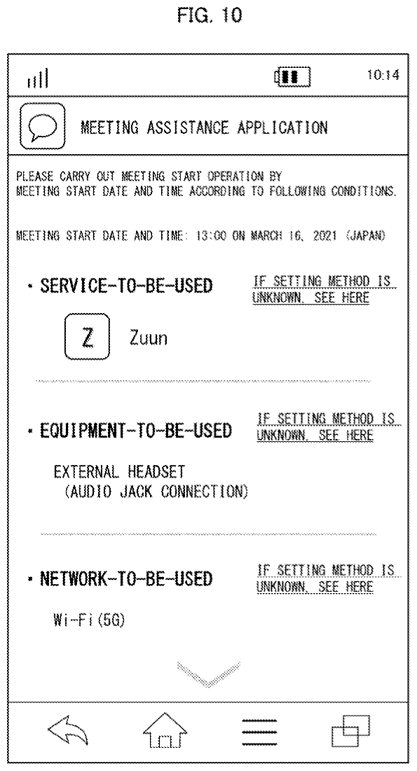

FIG. 10 is a diagram illustrating an example of a notification screen that is displayed on the display section 42 of the user terminal 2. The notification screen illustrated in FIG. 10 is a screen generated by the execution section 53 of the user terminal 2 of the user A based on the decision-necessary item 91 illustrated in FIG. 9. When the reception section 52 of the user terminal 2 has received an instruction including the decision-necessary item 91 illustrated in FIG. 9, the execution section 53 executes a predetermined process based on the decision-necessary item 91 in accordance with the instruction. As an example of the predetermined process, the execution section 53 executes a process of generating the notification screen illustrated in FIG. 10 based on the decision-necessary item 91, and a process of causing the display section 42 to display the notification screen.

For example, the notification screen includes regions indicating respective decision-necessary items of a service-to-be-used, equipment-to-be-used, and a network-to-be-used that are included in the decision-necessary item 91. The notification screen may include information of a start date and time of a web meeting as information for specifying the web meeting that is to be held.

By displaying the notification screen on the display section 42, it is possible to notify the user A that it is necessary to:
(1) activate “Zuun” as the meeting application 54;
(2) connect an external headset to the audio jack; and
(3) connect to the communication network NW via Wi-Fi (5 G),
   in order to participate in a web meeting that starts at 13:00 on Mar. 16, 2021.

Note that the notification screen may include, for a user who does not know how to apply each of the decision-necessary items, link information for guiding the user to a screen illustrating application procedures in detail. As illustrated in FIG. 10, the link information may be realized by text information such as “IF SETTING METHOD IS UNKNOWN, SEE HERE”. Thus, it is possible to present details of a method of applying the decision-necessary item to a user who cannot start a web meeting only by confirming the decision-necessary item, and thus it is possible to allow the user to correctly carry out pre-setting for starting the web meeting.

(Variation of Input Information)

The information that can be input by a user as input information is not limited to service designation information, data type designation information, and equipment designation information. For example, the user may be capable of inputting, as input information, network designation information indicating a communication network that the user would like to use in a web meeting. The transmission section 51 may include, based on a detection result of communication performance, information indicating which communication network has best communication performance in a GUI screen for inputting network designation information. This allows the user to select a network having the best communication performance. In a case where a network in the decision-necessary item is decided based on the network designation information, the item decision process may omit the process of step S22.

(Variation of Changing Equipment Information)

Upon connection of audiovisual equipment to the user terminal 2, the transmission section 51 may transmit, to the assistance server 1, peripheral equipment type information indicating the audiovisual equipment via the communication section 41. Thus, the audiovisual equipment is added to the storage section 11 of the assistance server 1 as peripheral equipment which can be used by the user terminal 2. Upon removal of audiovisual equipment from the user terminal 2, the transmission section 51 may transmit, to the assistance server 1, peripheral equipment type information which has been updated not to include the audiovisual equipment via the communication section 41. Thus, the assistance server 1 may delete, in the storage section 11, the audiovisual equipment from the peripheral equipment which is usable by the user terminal 2.

### Example Effect of Second Example Embodiment

As described above, the assistance server 1 according to the present example embodiment employs the configuration in which a decision-necessary item is decided based on pieces of terminal-specific information of respective two or more participant terminals. Therefore, according to the assistance server 1 of the present example embodiment, it is possible to bring about an example effect of enabling more preferable setting as a whole while taking into consideration both circumstances of the plurality of participants of a remote conversation.

In the assistance server 1 according to the present example embodiment, the configuration is employed in which terminal-specific information transmitted from a participant terminal is acquired before a remote conversation starts, a decision-necessary item is decided based on the acquired terminal-specific information in response to acquisition of the terminal-specific information, and the participant terminal is instructed to execute a predetermined process based on the decision-necessary item which has been decided. Therefore, according to the assistance server 1 of the present example embodiment, it is possible to bring about an example effect of causing a participant terminal to execute a predetermined process for starting a remote conversation before starting the remote conversation. Therefore, according to the assistance server 1 of the present example embodiment, it is possible to assist preparation by a participant to start a remote conversation.

In the assistance server 1 according to the present example embodiment, the terminal-specific information includes information pertaining to a network environment at a predetermined time period before a scheduled start time of a remote conversation, the network environment being usable by the participant terminal. Therefore, according to the assistance server 1 of the present example embodiment, it is possible to bring about an example effect of deciding a decision-necessary item while taking into consideration a network environment which is usable by a participant terminal.

In the assistance server 1 according to the present example embodiment, the terminal-specific information includes information indicating a processing load that is applied to a participant terminal at a predetermined time period before the scheduled start time of the remote conversation. Therefore, according to the assistance server 1 of the present example embodiment, it is possible to bring about an example effect of deciding a decision-necessary item while taking into consideration a processing load that is applied to a participant terminal.

In the assistance server 1 according to the present example embodiment, the terminal-specific information includes information indicating a type of a remote conversation service for carrying out the remote conversation, the remote conversation service being usable by the participant terminal. Therefore, according to the assistance server 1 of the present example embodiment, it is possible to bring about an example effect of deciding a decision-necessary item while taking into consideration a remote conversation service which is usable by a participant terminal.

In the assistance server 1 according to the present example embodiment, the terminal-specific information includes information indicating at least one of (i) audiovisual equipment which is built into the participant terminal, (ii) audiovisual equipment which is connectable to the participant terminal via an input-output interface, and (iii) the input-output interface which is included in the participant terminal. Therefore, according to the assistance server 1 of the present example embodiment, it is possible to bring about an example effect of deciding a decision-necessary item while taking into consideration audiovisual equipment which is usable for a remote conversation.

In the assistance server 1 according to the present example embodiment, the terminal-specific information includes information indicating a type of audiovisual data that is transmitted to and received from another participant terminal by the participant terminal in the remote conversation. Therefore, according to the assistance server 1 of the present example embodiment, it is possible to bring about an example effect of deciding a decision-necessary item while taking into consideration audiovisual data which is transmitted to and received from another participant terminal by the participant terminal in the remote conversation.

The assistance server 1 according to the present example embodiment employs the configuration of deciding a type of a remote conversation service that is used to carry out the remote conversation. Therefore, according to the assistance server 1 of the present example embodiment, it is possible to bring about an example effect of causing the participant terminal to execute a predetermined process for the participant to carry out setting for using the remote conversation service.

The assistance server 1 according to the present example embodiment employs the configuration of deciding a type of audiovisual equipment that is used by the participant in the remote conversation. Therefore, according to the assistance server 1 of the present example embodiment, it is possible to bring about an example effect of causing the participant terminal to execute a predetermined process for the participant to carry out setting for using the audiovisual equipment in the remote conversation.

The assistance server 1 according to the present example embodiment employs the configuration of deciding a type of a network which is used by the participant terminal for carrying out the remote conversation. Therefore, according to the assistance server 1 of the present example embodiment, it is possible to bring about an example effect of causing the participant terminal to execute a predetermined process for the participant to carry out setting for using the network in the remote conversation.

As described above, the user terminal 2 according to the present example embodiment employs the configuration of notifying a participant of a decision-necessary item. Therefore, according to the user terminal 2 of the present example embodiment, a participant of a remote conversation can prepare for starting the remote conversation after confirming the decision-necessary item. Therefore, it is possible to bring about an example effect of allowing a participant to easily carry out the preparation.

### Third Example Embodiment

The following description will discuss a third example embodiment of the present invention in detail with reference to the drawings. The same reference numerals are given to constituent elements which have functions identical with those described in the foregoing example embodiments, and descriptions as to such constituent elements are not repeated.

(Configuration of Assistance Server 1)

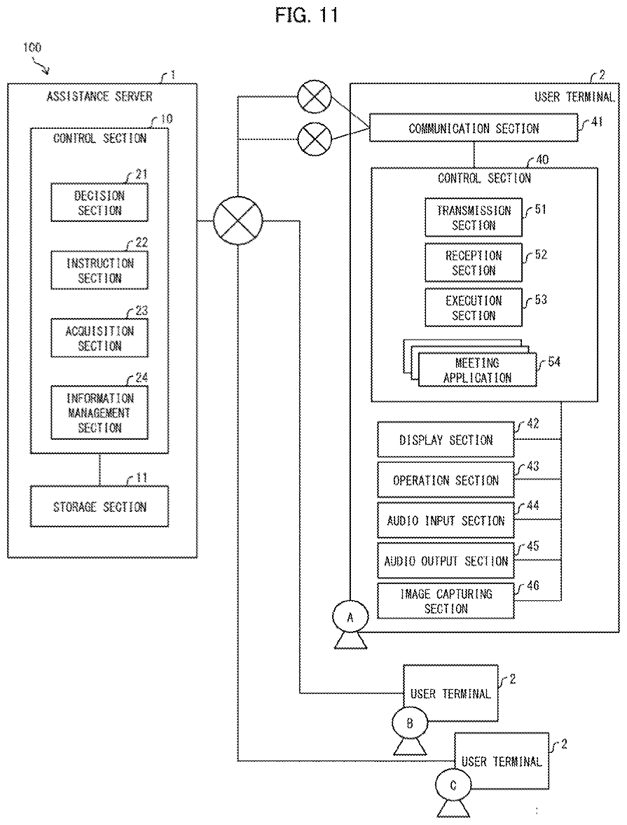

FIG. 11 is a diagram illustrating a configuration of an assistance system 100 including an assistance server 1 according to the present example embodiment. The assistance server 1 of the present example embodiment differs from the assistance server 1 described in the foregoing example embodiments in that the control section 10 further includes an information management section 24 in addition to the decision section 21, the instruction section 22, and the acquisition section 23.

The acquisition section 23 according to the present example embodiment acquires terminal-specific information including at least a scheduled start time of a web meeting, which has been transmitted from the user terminal 2 before a remote conversation starts. For example, at a time point when holding of a web meeting is decided, the acquisition section 23 first acquires, from the user terminal 2, terminal-specific information including a scheduled start time of the web meeting. At this time, the acquisition section 23 may acquire, together with the scheduled start time, another piece of terminal-specific information. The terminal-specific information other than the scheduled start time has been described in the second example embodiment, and therefore the description thereof will not be repeated here. Each of the pieces of terminal-specific information which are acquired by the acquisition section 23 is associated with a terminal ID.

The information management section 24 causes the storage section 11 to store, for each of user terminals 2, terminal-specific information including at least the scheduled start time which has been acquired by the acquisition section 23. The information management section 24 causes the storage section 11 to store the acquired terminal-specific information in association with the terminal ID.

The decision section 21 according to the present example embodiment decides a decision-necessary item based on at least terminal-specific information stored in the storage section 11. For example, by a predetermined time period before the scheduled start time of the web meeting, the decision section 21 decides a decision-necessary item based on terminal-specific information stored in the storage section 11. In a case where a piece of terminal-specific information has been additionally acquired from the user terminal 2 by a predetermined time period before the scheduled start time, the decision section 21 may decide a decision-necessary item while taking into consideration the additional piece of terminal-specific information.

The instruction section 22 according to the present example embodiment instructs, a predetermined time period before the scheduled start time stored in the storage section 11, the user terminal 2 to execute a predetermined process based on a decision-necessary item. Specifically, at a predetermined time period before the scheduled start time of the web meeting, the instruction section 22 transmits, to the user terminal 2, an instruction including a decision-necessary item which has been decided before that time point.

### Example Effect of Third Example Embodiment

As described above, the assistance server 1 according to the present example embodiment employs the configuration of: acquiring terminal-specific information that includes at least a scheduled start time of a remote conversation and that has been transmitted from a participant terminal before the remote conversation starts; causing the acquired terminal-specific information to be stored in a storage apparatus for each participant terminal; deciding a decision-necessary item based on at least the terminal-specific information stored in the storage apparatus; and instructing, a predetermined time period before the scheduled start time stored in the storage apparatus, the participant terminal to execute a predetermined process based on the decided decision-necessary item. Therefore, according to the assistance server 1 of the present example embodiment, it is possible to bring about an example effect of automatically instructing, a predetermined time period before a scheduled start time, a participant terminal to execute a predetermined process.

### Fourth Example Embodiment

The following description will discuss a fourth example embodiment of the present invention in detail with reference to the drawings. The same reference numerals are given to constituent elements which have functions identical with those described in the foregoing example embodiments, and descriptions as to such constituent elements are not repeated.

(Configuration of User Terminal 2)

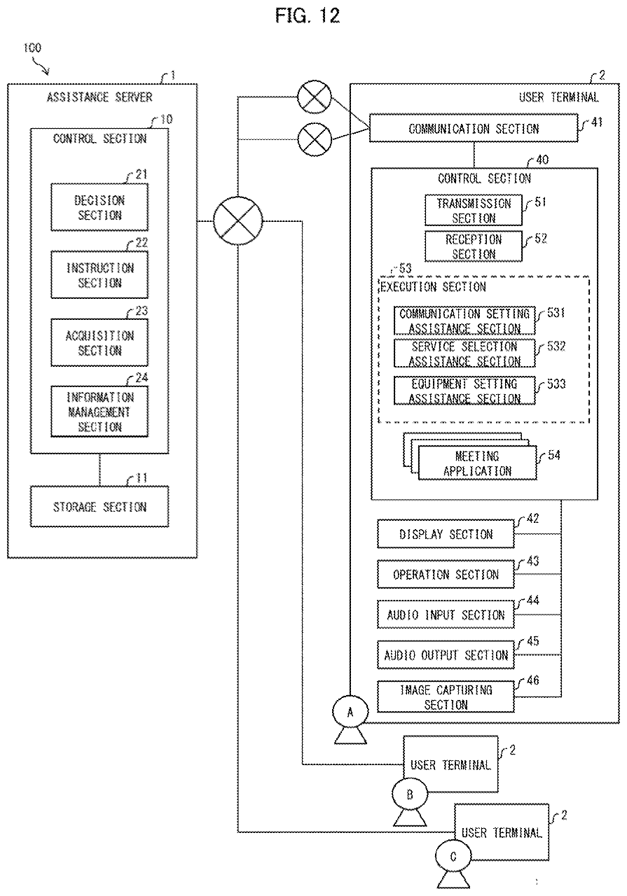

FIG. 12 is a diagram illustrating a configuration of an assistance system 100 including a user terminal 2 according to the present example embodiment. The user terminal 2 of the present example embodiment is different from the user terminal 2 described in the foregoing example embodiments in that the control section 40 includes a communication setting assistance section 531, a service selection assistance section 532, and an equipment setting assistance section 533 as the execution section 53.

The above sections as the execution section 53 present, to a user, a procedure of applying a decision-necessary item to the user terminal 2. For example, the above sections as the execution section 53 according to the present example embodiment sequentially execute a process of presenting a procedure for each of a plurality of decision-necessary items in accordance with a predetermined application order of applying the plurality of decision-necessary items.

The communication setting assistance section 531 assists, based on a network-to-be-used among decision-necessary items, a communication network setting operation which is carried out by a user.

The service selection assistance section 532 assists, based on a service-to-be-used among decision-necessary items, various setting operations by a user for a web meeting service which is used by the user in a web meeting.

The equipment setting assistance section 533 assists, based on equipment-to-be-used among decision-necessary items, various setting operations by a user in relation to audiovisual equipment so that the user can use the equipment-to-be-used in a web meeting.

Specifically, the communication setting assistance section 531 assists, among decision-necessary items, setting of a communication network to which the user terminal 2 is connected in a web meeting. For example, the communication setting assistance section 531 determines whether or not a communication network to which the user terminal 2 is connected matches a network-to-be-used indicated in the decision-necessary item. In a case where it has been determined that the networks match, the communication setting assistance section 531 notifies the service selection assistance section 532 of the fact. Alternatively, in addition to the above notification, the communication setting assistance section 531 may notify the user that the setting of the communication network does not need to be changed.

In a case where it has been determined that the communication network to which the user terminal 2 is connected does not match the network-to-be-used, for example, the communication setting assistance section 531 causes the display section 42 to display a network setting screen indicating an operation procedure for changing the communication network to which the user terminal 2 is connected. The network setting screen may include, for example, an area of an icon that is to be selected for changing a communication network to which the user terminal 2 is connected. In a case where the network-to-be-used is the Internet via Wi-Fi, the network setting screen may include a service set identifier. Note that the service set identifier only needs to be stored in the user terminal 2 or the assistance server 1 in advance in association with information indicating Wi-Fi. For example, the control section 40 acquires a signal of a predetermined input operation via the operation section 43 to carry out the association.

In a case where the communication network to which the user terminal 2 is connected has been changed, the communication setting assistance section 531 determines whether or not a communication network after the change matches the network-to-be-used. In a case where the networks match, the communication setting assistance section 531 notifies the service selection assistance section 532 of the fact, and also hides the network setting screen. Instead of the network setting screen, the communication setting assistance section 531 may cause the display section 42 to display a screen for notifying the user that the user terminal 2 has been connected to the network-to-be-used. In a case where the networks do not match, the communication setting assistance section 531 notifies the user of the fact and maintains the display of the network setting screen.

The service selection assistance section 532 assists, among decision-necessary items, setting of a web meeting service that is used in a web meeting. For example, upon receipt of a notification from the communication setting assistance section 531, the service selection assistance section 532 causes the display section 42 to display a service setting screen indicating an operation procedure for starting use of a web meeting service indicated by the decision-necessary item. In a case where the web meeting service is available by a meeting application 54 which is dedicated to the web meeting service and which is installed in the user terminal 2, the service setting screen may include, for example, an image indicating a position at which an icon of the application is displayed.

The service selection assistance section 532 may assist various types of setting after activation of the meeting application 54. For example, in a case where it is necessary to input, in the activated meeting application 54, at least one of an ID for identifying a web meeting and a password, the service selection assistance section 532 may cause the display section 42 to display at least one of the ID and the password, and prompt the user to input the ID and/or the password. The ID and/or the password may be stored in the user terminal 2 or the assistance server 1 in advance.

Upon completion of various types of setting of the meeting application 54, the service selection assistance section 532 notifies the equipment setting assistance section 533 of this fact.

The equipment setting assistance section 533 assists, among decision-necessary items, setting of audiovisual equipment which is used by the user in a web meeting. For example, upon receipt of a notification from the service selection assistance section 532, the equipment setting assistance section 533 determines whether or not audiovisual equipment that is set in the web meeting service matches equipment-to-be-used indicated by the decision-necessary item. For example, in a case where the audiovisual equipment indicated by the decision-necessary item is an external headset and an image capturing device such as the image capturing section 46 is not to be used, the equipment setting assistance section 533 determines whether or not settings of an audio output device and an audio input device in the meeting application 54 indicate the above external headset. Moreover, the equipment setting assistance section 533 determines whether or not the meeting application 54 is set not to use an image capturing device.

In a case where it has been determined that various settings related to audiovisual equipment in the meeting application 54 match equipment-to-be-used indicated by the decision-necessary item, the equipment setting assistance section 533 ends the above series of setting processes. Alternatively, the equipment setting assistance section 533 may notify the user that the setting has been completed.

Meanwhile, in a case where it has been determined that various settings related to audiovisual equipment do not match equipment-to-be-used indicated by the decision-necessary item, for example, the equipment setting assistance section 533 causes the display section 42 to display an equipment setting screen indicating an operation procedure for changing various settings related to audiovisual equipment. The apparatus setting screen may include, for example, an image indicating a position to be clicked on the meeting application 54 in order to change a setting of audiovisual equipment.

In a decision-necessary item that is transmitted from the assistance server 1 according to the present example embodiment in order for the equipment setting assistance section 533 to assist setting of audiovisual equipment on an application, the service-to-be-used may include, in addition to a type of web meeting service, setting information on the web meeting service. The setting information is information indicating procedures of various types of setting to be carried out after activation of a meeting application 54 for a web meeting service, and includes, as a specific example, information indicating a procedure of changing a setting of audiovisual equipment on the meeting application 54.

In the present example embodiment, the predetermined application order of applying the plurality of decision-necessary items has been described as being the order of a communication network, a web meeting service, and audiovisual equipment. Note, however, that the application order of decision-necessary items may be arbitrarily determined.

(Variation of Presentation Order)

The execution section 53 may present, at a time, procedures for applying a plurality of decision-necessary items to the user. For example, the execution section 53 may cause the display section 42 to display a single image indicating setting procedures of a network, a web meeting service, and audiovisual equipment which are indicated by decision-necessary items.

(Variation of Assistance of Setting Audiovisual Equipment)

The equipment setting assistance section 533 may carry out assistance based on a decision-necessary item indicating audiovisual equipment which is not connected to the user terminal 2. For example, the equipment setting assistance section 533 may provide the user with notification for prompting connection to the audiovisual equipment, or may provide the user with notification for prompting use of audiovisual equipment built into the user terminal 2 in place of that audiovisual equipment. In the former case, the equipment setting assistance section 533 may further cause the display section 42 to display an image indicating a position (e.g., a position of a connection terminal) of an input-output interface to which the audiovisual equipment is to be connected.

(Variation of Assistance Content)

The execution section 53 may carry out a process of assisting a user after a web meeting starts. For example, the communication setting assistance section 531 may detect communication performance of a network in use during a web meeting. In a case where the communication performance of the network deteriorates or communication via the network becomes impossible, the communication setting assistance section 531 may notify the user of the fact. Alternatively, the communication setting assistance section 531 may be connected to another network and notifies the user of the fact.

(Variation of Assistance Server)

The assistance server according to the present example embodiment may be the assistance server 1 described in any of the first through third example embodiments.

As described above, the user terminal 2 according to the present example embodiment employs the configuration in which a procedure of applying a decision-necessary item to the user terminal 2 is presented to a participant. Therefore, according to the user terminal 2 of the present example embodiment, it is possible to bring about an example effect of starting a remote conversation even if a participant is not familiar with conduct of a remote conversation.

The user terminal 2 according to the present example embodiment employs the configuration in which a process of presenting a procedure is sequentially executed for each of a plurality of decision-necessary items in accordance with a predetermined application order of applying the plurality of decision-necessary items. Therefore, according to the user terminal 2 of the present example embodiment, it is possible to bring about an example effect of allowing a participant who is not familiar with conduct of a remote conversation to correctly set, in order, the decision-necessary items and start the remote conversation.

### Software Implementation Example

The functions of part of or all of the assistance server 1 (information processing apparatus) and the user terminal 2 (participant terminal) can be realized by hardware such as an integrated circuit (IC chip) or can be alternatively realized by software.

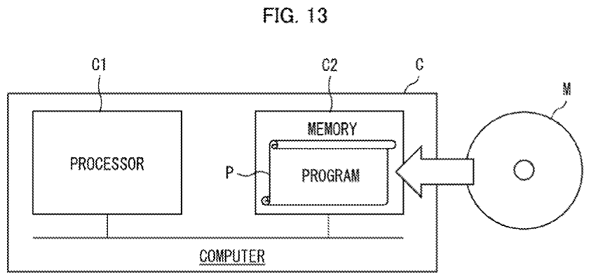

In the latter case, each of the assistance server 1 and the user terminal 2 is realized by, for example, a computer that executes instructions of a program that is software realizing the foregoing functions. FIG. 13 illustrates an example of such a computer (hereinafter, referred to as “computer C”). The computer C includes at least one processor C1 and at least one memory C2. The memory C2 stores a program P for causing the computer C to function as the assistance server 1 and the user terminal 2. In the computer C, the processor C1 reads the program P from the memory C2 and executes the program P, so that the functions of the assistance server 1 and the user terminal 2 are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following supplementary notes.

### Supplementary Note 1

An information processing apparatus, including: a decision means that decides, based on terminal-specific information of a participant terminal which is used by a participant of a remote conversation, an item to be decided for starting the remote conversation; and an instruction means that instructs the participant terminal to execute a predetermined process for starting the remote conversation in accordance with the item which has been decided.

### Supplementary Note 2

The information processing apparatus according to supplementary note 1, in which: the decision means decides the item based on pieces of terminal-specific information of respective two or more participant terminals, each of the two or more participant terminals being the participant terminal.

### Supplementary Note 3

The information processing apparatus according to supplementary note 1 or 2, further including an acquisition means that acquires the terminal-specific information which has been transmitted from the participant terminal before the remote conversation starts, in which: upon acquisition of the terminal-specific information by the acquisition means, the decision means decides the item based on the terminal-specific information which has been acquired, and the instruction means instructs the participant terminal to execute the predetermined process based on the item which has been decided.

### Supplementary Note 4

The information processing apparatus according to supplementary note 3, further including an information management means that causes a storage apparatus to store, for each participant terminal, the terminal-specific information which has been acquired by the acquisition means and which includes at least a scheduled start time of the remote conversation, in which: the decision means decides the item based on at least the terminal-specific information which is stored in the storage apparatus; and the instruction means instructs, a predetermined time period before the scheduled start time stored in the storage apparatus, the participant terminal to execute the predetermined process based on the item which has been decided.

### Supplementary Note 5

The information processing apparatus according to any one of supplementary notes 1 through 4, in which: the terminal-specific information includes information pertaining to a network environment at a predetermined time period before a scheduled start time of the remote conversation, the network environment being usable by the participant terminal.

### Supplementary Note 6

The information processing apparatus according to any one of supplementary notes 1 through 5, in which: the terminal-specific information includes information indicating a processing load that is applied to the participant terminal at a predetermined time period before a scheduled start time of the remote conversation.

### Supplementary Note 7

The information processing apparatus according to any one of supplementary notes 1 through 6, in which: the terminal-specific information includes information indicating a type of a remote conversation service for carrying out the remote conversation, the remote conversation service being usable by the participant terminal.

### Supplementary Note 8

The information processing apparatus according to any one of supplementary notes 1 through 7, in which: the terminal-specific information includes information indicating at least one of (i) audiovisual equipment which is built into the participant terminal, (ii) audiovisual equipment which is connectable to the participant terminal via an input-output interface, and (iii) the input-output interface which is included in the participant terminal.

### Supplementary Note 9

The information processing apparatus according to any one of supplementary notes 1 through 8, in which: the terminal-specific information includes information indicating a type of audiovisual data that is transmitted to and received from another participant terminal by the participant terminal in the remote conversation.

### Supplementary Note 10

The information processing apparatus according to any one of supplementary notes 1 through 9, in which: the decision means decides a type of a remote conversation service that is used to carry out the remote conversation.

### Supplementary Note 11

The information processing apparatus according to any one of supplementary notes 1 through 10, in which: the decision means decides a type of audiovisual equipment that is used by the participant in the remote conversation.

### Supplementary Note 12

The information processing apparatus according to any one of supplementary notes 1 through 11, in which: the decision means decides a type of a network that is used by the participant terminal for carrying out the remote conversation.

### Supplementary Note 13

A participant terminal used by a participant of a remote conversation, the participant terminal including: a transmission means that transmits terminal-specific information of the participant terminal to an information processing apparatus that assists conduct of the remote conversation; a reception means that receives, from the information processing apparatus, an instruction for executing a predetermined process for starting the remote conversation in accordance with an item which has been decided by the information processing apparatus based on the terminal-specific information and which is to be decided for starting the remote conversation; and an execution means that executes the predetermined process in accordance with the instruction.

### Supplementary Note 14

The participant terminal according to supplementary note 13, in which: the execution means notifies the participant of the item.

### Supplementary Note 15

The participant terminal according to supplementary note 13, in which: the execution means presents, to the participant, a procedure for applying the item to the participant terminal.

### Supplementary Note 16

The participant terminal according to supplementary note 15, in which: the execution means sequentially executes a process of presenting the procedure for each of a plurality of items in accordance with a predetermined application order of applying the plurality of items.

### Supplementary Note 17

An assistance system comprising a participant terminal which is used by a participant of a remote conversation and an information processing apparatus which assists conduct of the remote conversation, the information processing apparatus including a decision means that decides, based on terminal-specific information, an item to be decided for starting the remote conversation, and an instruction means that instructs the participant terminal to execute a predetermined process for starting the remote conversation in accordance with the item which has been decided, and the participant terminal including a transmission means that transmits the terminal-specific information to the information processing apparatus, a reception means that receives, from the information processing apparatus, an instruction by the instruction means, and an execution means that executes the predetermined process in accordance with the instruction.

### Supplementary Note 18

An information processing method, including: deciding, by at least one processor, an item to be decided for starting a remote conversation based on terminal-specific information of a participant terminal which is used by a participant of the remote conversation; and instructing, by the at least one processor, the participant terminal to execute a predetermined process for starting the remote conversation in accordance with the item which has been decided.

### Supplementary Note 19

A method for assisting a remote conversation, the method including: transmitting, by a participant terminal used by a participant of a remote conversation, terminal-specific information of the participant terminal to an information processing apparatus which assists conduct of the remote conversation; deciding, by the information processing apparatus, an item to be decided for starting the remote conversation, based on the terminal-specific information; instructing, by the information processing apparatus, the participant terminal to execute a predetermined process for starting the remote conversation in accordance with the item which has been decided; receiving, by the participant terminal, an instruction for executing the predetermined process from the information processing apparatus; and executing, by the participant terminal, the predetermined process in accordance with the instruction.

### Supplementary Note 20

An assistance program for causing a computer to function as a participant terminal used by a participant of a remote conversation, the assistance program causing the computer to function as: a transmission means that transmits terminal-specific information of the participant terminal to an information processing apparatus that assists conduct of the remote conversation; a reception means that receives, from the information processing apparatus, an instruction for executing a predetermined process for starting the remote conversation in accordance with an item which has been decided by the information processing apparatus based on the terminal-specific information and which is to be decided for starting the remote conversation; and an execution means that executes the predetermined process in accordance with the instruction.

### Additional Remark 3

Furthermore, some of or all of the foregoing example embodiments can also be expressed as below.

An information processing apparatus including at least one processor, the at least one processor carrying out: a decision process of deciding, based on terminal-specific information of a participant terminal which is used by a participant of a remote conversation, an item to be decided for starting the remote conversation; and an instruction process of instructing the participant terminal to execute a predetermined process for starting the remote conversation in accordance with the item which has been decided.

Note that the information processing apparatus can further include a memory. The memory can store a program for causing the processor to carry out the decision process and the instruction process. The program can be stored in a computer-readable non-transitory tangible storage medium.

A participant terminal used by a participant of a remote conversation, the participant terminal including at least one processor, the at least one processor carrying out: a transmission process of transmitting terminal-specific information of the participant terminal to an information processing apparatus that assists conduct of the remote conversation; a reception process of receiving, from the information processing apparatus, an instruction for executing a predetermined process for starting the remote conversation in accordance with an item which has been decided by the information processing apparatus based on the terminal-specific information and which is to be decided for starting the remote conversation; and an execution process of executing the predetermined process in accordance with the instruction.

Note that the participant terminal can further include a memory. The memory can store a program for causing the processor to carry out the transmission process, the reception process, and the execution process. The program can be stored in a computer-readable non-transitory tangible storage medium.

### REFERENCE SIGNS LIST

1: Assistance server (information processing apparatus)
2: User terminal (participant terminal)
11: Storage section (storage apparatus)
21: Decision section (decision means)
22: Instruction section (instruction means)
23: Acquisition section (acquisition means)
24: Information management section (information management means)
41: Communication section (peripheral equipment)
42: Display section (peripheral equipment, audiovisual equipment)
43: Operation section (peripheral equipment, audiovisual equipment)
44: Audio input section (peripheral equipment, audiovisual equipment)
45: Audio output section (peripheral equipment, audiovisual equipment)
46: Image capturing section (peripheral equipment, audiovisual equipment)
51: Transmission section (transmission means)
52: Reception section (reception means)
53: Execution section (execution means)
54: Meeting application
71, 72: Terminal-specific information
100: Assistance system
531: Communication setting assistance section (execution means)
532: Service selection assistance section (execution means)
533 Equipment setting assistance section (execution means)

What is claimed is:

1. An information processing apparatus comprising at least one processor, the at least one processor carrying out:
a decision process of deciding, based on terminal-specific information of a participant terminal which is used by a participant of a remote conversation, an item to be decided for starting the remote conversation; and
an instruction process of instructing the participant terminal to execute a predetermined process for starting the remote conversation in accordance with the item which has been decided.

2. The information processing apparatus according to claim 1, wherein:
in the decision process, the at least one processor decides the item based on pieces of terminal-specific information of respective two or more participant terminals, each of the two or more participant terminals being said participant terminal.

3. The information processing apparatus according to claim 1, wherein:
the at least one processor further carries out an acquisition process of acquiring the terminal-specific information which has been transmitted from the participant terminal before the remote conversation starts; and
upon acquisition of the terminal-specific information in the acquisition process,
in the decision process, the at least one processor decides the item based on the terminal-specific information which has been acquired, and
in the instruction process, the at least one processor instructs the participant terminal to execute the predetermined process based on the item which has been decided.

4. The information processing apparatus according to claim 3, wherein:
the at least one processor further carries out an information management process of causing a storage apparatus to store, for each participant terminal, the terminal-specific information which has been acquired in the acquisition process and which includes at least a scheduled start time of the remote conversation;
in the decision process, the at least one processor decides the item based on at least the terminal-specific information which is stored in the storage apparatus; and
in the instruction process, the at least one processor instructs, a predetermined time period before the scheduled start time stored in the storage apparatus, the participant terminal to execute the predetermined process based on the item which has been decided.

5. The information processing apparatus according to claim 1, wherein:
the terminal-specific information includes information pertaining to a network environment at a predetermined time period before a scheduled start time of the remote conversation, the network environment being usable by the participant terminal.

6. The information processing apparatus according to claim 1, wherein:
the terminal-specific information includes information indicating a processing load that is applied to the participant terminal at a predetermined time period before a scheduled start time of the remote conversation.

7. The information processing apparatus according to claim 1, wherein:
the terminal-specific information includes information indicating a type of a remote conversation service for carrying out the remote conversation, the remote conversation service being usable by the participant terminal.

8. The information processing apparatus according to claim 1, wherein:
the terminal-specific information includes information indicating at least one of (i) audiovisual equipment which is built into the participant terminal, (ii) audiovisual equipment which is connectable to the participant terminal via an input-output interface, and (iii) the input-output interface which is included in the participant terminal.

9. The information processing apparatus according to claim 1, wherein:
the terminal-specific information includes information indicating a type of audiovisual data that is transmitted to and received from another participant terminal by the participant terminal in the remote conversation.

10. The information processing apparatus according to claim 1, wherein:
in the decision process, the at least one processor decides a type of a remote conversation service that is used to carry out the remote conversation.

11. The information processing apparatus according to claim 1, wherein:
in the decision process, the at least one processor decides a type of audiovisual equipment that is used by the participant in the remote conversation.

12. The information processing apparatus according to claim 1, wherein:
in the decision process, the at least one processor decides a type of a network that is used by the participant terminal for carrying out the remote conversation.

13. A participant terminal used by a participant of a remote conversation, said participant terminal comprising at least one processor, the at least one processor carrying out:
a transmission process of transmitting terminal-specific information of said participant terminal to an information processing apparatus that assists conduct of the remote conversation;
a reception process of receiving, from the information processing apparatus, an instruction for executing a predetermined process for starting the remote conversation in accordance with an item which has been decided by the information processing apparatus based on the terminal-specific information and which is to be decided for starting the remote conversation; and
an execution process of executing the predetermined process in accordance with the instruction.

14. The participant terminal according to claim 13, wherein:
in the execution process, the at least one processor notifies the participant of the item.

15. The participant terminal according to claim 13, wherein:
in the execution process, the at least one processor presents, to the participant, a procedure for applying the item to said participant terminal.

16. The participant terminal according to claim 15, wherein:
in the execution process, the at least one processor sequentially executes a process of presenting the procedure for each of a plurality of items in accordance with a predetermined application order of applying the plurality of items.

17. An assistance system comprising a participant terminal which is used by a participant of a remote conversation and an information processing apparatus which is recited in claim 1,
the at least one processor included in the information processing apparatus carrying out
the decision process, and
the instruction process, and
the participant terminal including at least one processor, the at least one processor included in the participant terminal carrying out
a transmission process of transmitting the terminal-specific information to the information processing apparatus,
a reception process of receiving, from the information processing apparatus, an instruction in the instruction process, and
an execution process of executing the predetermined process in accordance with the instruction.

18. An information processing method, comprising:
deciding, by at least one processor, an item to be decided for starting a remote conversation based on terminal-specific information of a participant terminal which is used by a participant of the remote conversation; and
instructing, by the at least one processor, the participant terminal to execute a predetermined process for starting the remote conversation in accordance with the item which has been decided.

19. (canceled)

20. A non-transitory storage medium storing an assistance program for causing a computer to function as a participant terminal recited in claim 13, the assistance program causing the computer to carry out:
the transmission process;
the reception process; and
the execution process.
